(19) United States
(12) Patent Application Publication
(10) Pub. No.: US 2010/0161132 A1
(43) Pub. Date: Jun. 24, 2010

(54) SYSTEM AND METHOD FOR MONITORING AN INDUSTRIAL PRODUCTION PROCESS

(76) Inventors: Manish Harish Bharati, Katy, TX (US); Phillip Guy Hamilton, Sugar Land, TX (US); Nirmal Tatavalli-Mittadar, Richmond, TX (US); Eugene Harry Theobald, Richmond, TX (US)

Correspondence Address: SHELL OIL COMPANY, P O BOX 2463, HOUSTON, TX, 772522463, US

(21) Appl. No.: 12/645,209

(22) Filed: Dec. 22, 2009

Related U.S. Application Data
(60) Provisional application No. 61/140,397, filed on Dec. 23, 2008.

(51) Int. Cl. G05B 13/04; G05B 23/00

(52) U.S. Cl. 700/266; 700/30; 700/32

(57) ABSTRACT

A system for monitoring an industrial production process includes one or more sensors configured to facilitate generating process data and a processor configured to calculate a value of a monitoring variable using the process data. The monitoring variable is optimized with respect to an abnormal space of a process space. The process space includes process parameters and principle components of a multivariate model of the process. The abnormal space includes a subspace of the process space.

This application claims priority to U.S. Provisional Application Ser. No. 61/140,397 filed Dec. 23, 2008, the entire disclosure of which is hereby incorporated by reference.

### TECHNICAL FIELD

This disclosure relates generally to systems and methods for monitoring an industrial production process.

### BACKGROUND

Industrial production processes are monitored to assess whether or not the processes are normal and stable. Typically, to assess whether or not the processes are normal and stable, parameters of the processes are monitored univariately. Here, as long as the process parameters stay within normal operating ranges, the process is considered to be normal. However, processes can be abnormal or unstable even when the process parameters are within normal operating ranges as changes in process parameters relative to one another can cause instability.

As an example, in an Ethylene Oxide Reactor (EOR), an unstable process can result in a post ignition event that is costly in terms of lost product, plant efficiency, and downtime. Since existing systems and methods for monitoring plant processes can indicate that a chemical plant process is stable and normal even when the process is unstable, operators can be unaware of the instability of the process in time to be able to take measures to stabilize the Ethylene Oxide Reactor and avoid a post ignition event.

Monitoring systems using multivariate statistical models may identify that a process fault exists, but do not necessarily identify what the particular process fault is in order allow operators to take the appropriate measures related to the particular fault. Examples of applied multivariate statistical analysis methods are described in U.S. Pat. No. 6,564,119, U.S. Pat. No. 6,607,577 B2, U.S. Pat. No. 6,885,907 B1.

A heretofore unaddressed need exists in the industry to address the aforementioned deficiencies and inadequacies. It would be useful to be able to detect a particular process fault such as instability that could lead to a post ignition event in order to be able to take measures to correct or stabilize the process.

### SUMMARY

The various embodiments of the present disclosure overcome the shortcomings of the prior art by providing a system and method for monitoring an industrial production process to be able to identify when the process is abnormal or unstable, or otherwise when a particular type of fault is present or is more likely to occur.

According to one aspect of the invention, a method for monitoring an industrial production process includes generating process data and calculating a value of a monitoring variable based at least in part on the process data. The monitoring variable is optimized with respect to an abnormal space of a process space. The process space includes process parameters and principle components of a multivariate model of the process. The abnormal space is a subspace of the process space.

According to another aspect of the invention, a system for monitoring an industrial production process includes one or more sensors configured to facilitate generating process data and a processor configured to calculate a value of a monitoring variable using the process data. The monitoring variable is optimized with respect to an abnormal space of a process space. The process space includes process parameters and principle components of a multivariate model of the process. The abnormal space is a subspace of the process space.

According to yet another aspect of the invention, a method for developing a monitoring variable includes generating a multivariate model of an industrial production process using process data that corresponds to normal process conditions. The multivariate model comprising process parameters and principle components that provide a process space. The method further includes identifying an abnormal space that is a subspace of the process space using process data that corresponds to abnormal process conditions. The abnormal space includes a subset of the process parameters and a subset of the principle components. The method further includes developing a monitoring variable as a function of process parameters consisting essentially of the subset of the process parameters and as a function of principle components consisting essentially of the subset of the principle components.

The foregoing has broadly outlined some of the aspects and features of the present invention, which should be construed to be merely illustrative of various potential applications of the teachings of the disclosure. Other beneficial results can be obtained by applying the disclosed information in a different manner or by combining various aspects of the disclosed embodiments. Accordingly, other aspects and a more comprehensive understanding may be obtained by referring to the detailed description of the exemplary embodiments taken in conjunction with the accompanying drawings, in addition to the scope defined by the claims.

### DESCRIPTION OF THE SEVERAL VIEWS OF THE DRAWINGS

FIG. 1 is a schematic diagram of a monitoring system, according to an exemplary embodiment of the disclosure.

FIG. 2 is a schematic diagram of a method for building a monitoring variable.

FIG. 3 is a plot representing process parameter data measured by a sensor of the monitoring system of FIG. 1.

FIG. 4 is a plot representing multivariate model data.

FIG. 5 is a chart representing plots of principle component data.

FIG. 6 is a contribution plot representing the contribution of process parameters to variation in the multivariate model data of FIG. 4.

FIG. 7 is a plot representing monitoring variable data.

### DETAILED DESCRIPTION

As required, detailed embodiments are disclosed herein. It must be understood that the disclosed embodiments may be embodied in various and alternative forms, and combinations thereof according to the teachings of the present disclosure. As used herein, the word “exemplary” is used expansively to refer to embodiments that serve as illustrations, specimens, models, or patterns. The figures are not necessarily to scale and some features may be exaggerated or minimized to show details of particular components. In other instances, well-known components, systems, materials, or methods have not been described in detail in order to avoid obscuring the present disclosure. Therefore, specific structural and functional details disclosed herein are not to be interpreted as limiting, but merely as a basis for the claims and as a representative basis for teaching one skilled in the art.

### Chemical Plant and Monitoring System

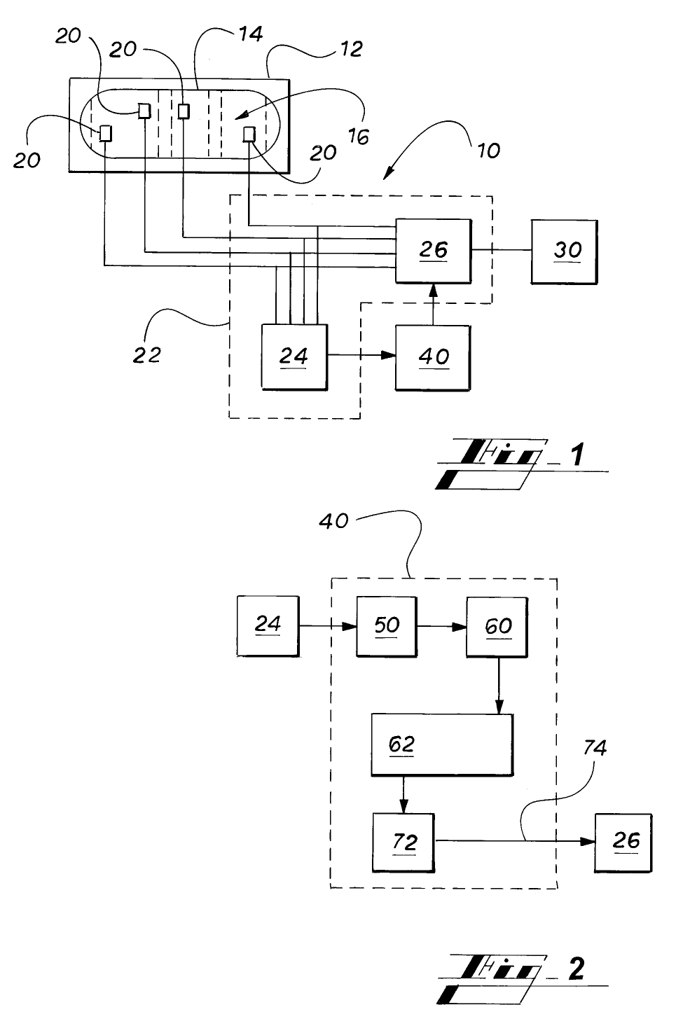

Referring to FIG. 1, a monitoring system 10 is schematically illustrated. For purposes of teaching, the monitoring system 10 is described in the context of a chemical plant 12 with an Ethylene Oxide Reactor (EOR) 14 where a process 16 is performed. However, the teachings of the disclosure can be applied to other industrial production facilities, plants, environments, processes, operations, and the like where a fault occurs. Examples of industrial production facilities include continuous chemical production facilities, batch chemical production facilities, petrochemical production facilities, refinery process facilities, refinery process facilities, downhole hydrocarbon systems, water production systems, subsystems thereof, combinations thereof, and the like.

The monitoring system 10 is configured to continuously monitor the process 16 of the Ethylene Oxide Reactor 14 in near real-time. Generally described, the illustrated monitoring system 10 collects, stores, processes, and displays data corresponding to parameters aₙ of the process 16. As used herein, the subscript “n” is used to index different process parameters aₙ. For purposes of illustration, the monitoring system 10 monitors N process parameters aₙ and n is a set of integers ranging from 1 to N. Each process parameter is measured at or digitized to correspond to times tₘ to generate process parameter data aₙ(tₘ). As used herein, the subscript “m” is used to index different measurement times tₘ. For example, m can be a set of integers ranging from 1 to M. It should be noted that N can be a large number, for example on the order of one hundred, such that the process parameter data aₙ(tₘ) is substantially large. The process parameter data aₙ(tₘ) can be represented in matrix form as

$${a}_{n} ( {t}_{m} ) = [ \overline{\begin{matrix}{a}_{1} ( {t}_{1} ) & … & {a}_{1} ( {t}_{M} ) \\ ⋮ & ⋱ & ⋮ \\ {a}_{N} ( {t}_{1} ) & … & {a}_{N} ( {t}_{M} )\end{matrix}} ] .$$

Process parameters aₙ can include temperature, temperature difference, operating pressure, product flow, velocity, density, coolant water flow rate, pump flow, chemical composition (such as reaction progress or catalyst performance), engineering and cost computation data, ultraviolet (UV) absorption, infrared (IR) spectroscopy, pH, aldehyde concentration, trace metal, contamination (such as sub-ppm-level feedstock contaminants including sulfur, acetylene, arsenic, HCl), ion level (such as sodium ion or silicon ion from absorbers), flammable approach, total ethylene oxide (EO) production, inlet oxygen concentration, inlet ethylene concentration, outlet ethylene oxide (EO) concentration, outlet carbon dioxide (CO₂) concentration, volumetric gas flow to the reactors, catalyst volume, gas hourly space velocity (GHSV), selectivity, catalyst temperatures, and skin temperatures. Certain of the process parameters aₙ can be directly measured and others are calculated as a function of measured process parameters aₙ. Process parameters aₙ can represent the quality of the product of the EOR 14.

The illustrated monitoring system 10 includes a plurality of sensors 20 that are configured to make measurements of process parameters aₙ of the process 16. The sensors 20 can include various types of sensors that are configured to measure the types of process parameters aₙ described above such as temperature sensors, pressure sensors, and the like. Various sensors 20 measure the process parameter data aₙ(tₘ) by monitoring bleed streams, photons, electrons, and the like.

Continuing with FIG. 1, the monitoring system 10 further includes a data management station 22 that collects, stores, and processes the process parameter data aₙ(tₘ). The data management station 22 includes a historian 24 where the process parameter data aₙ(tₘ) that is measured by the sensors 20 can be stored and accessed. Process parameter data aₙ(tₘ) can also include data that is manually added to the historian 24 or otherwise processed before being added to the historian 24. The data management station 22 further includes a processor 26 that processes the process parameter data aₙ(tₘ) into a form that facilitates monitoring the process 16. The output of the processor 26 or data management station 22 can be in the form of machine readable instructions, graphical displays, audio signals, visual signals, combinations of thereof, and the like. The illustrated monitoring system 10 includes a display module 30 to which the process parameter data aₙ(tₘ) is output after being processed by the processor 26. For example, the display module 30 can include a human machine interface (HMI) or a user interface (UI).

The processor 26 processes a subset of the process parameter data aₙ(tₘ) according to a monitoring variable d. Referring to FIGS. 1 and 2, an exemplary method for developing the monitoring variable d is now described. The monitoring variable d is developed in a development module 40 that is configured to access process parameter data aₙ(tₘ) from the historian 24 and to implement the monitoring variable d in the processor 26.

### Multivariate Model

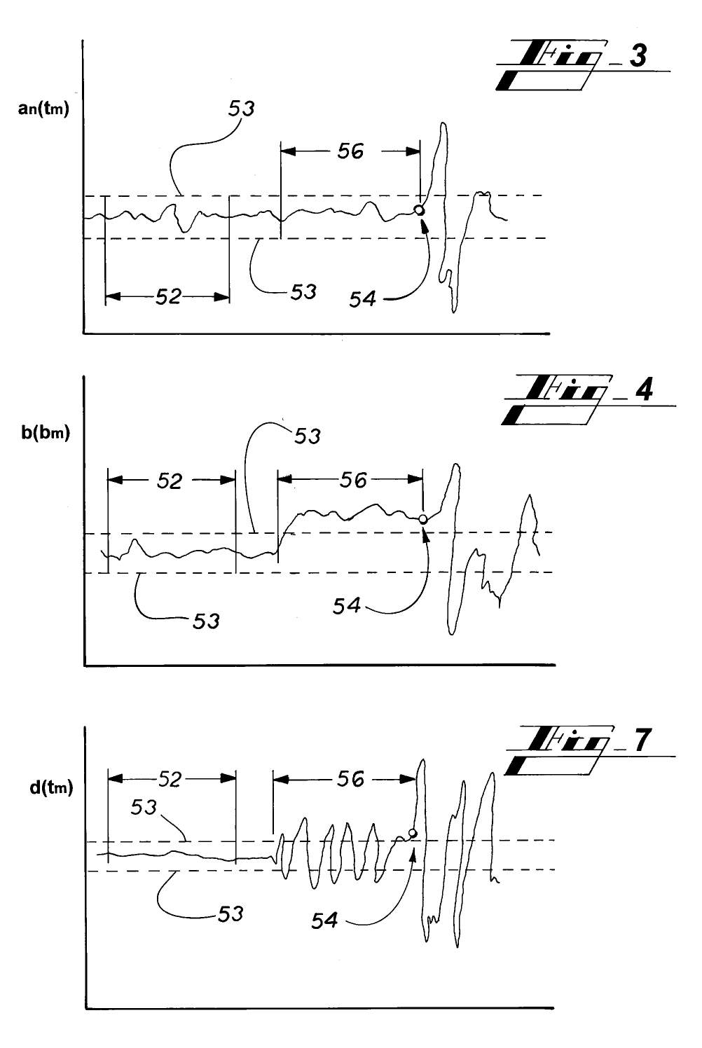

According to a first step 50 of an exemplary method, a multivariate model b is generated. The multivariate model b can include a principle component analysis (PCA) model, a partial least squares (PLS) model, and the like. For purposes of teaching, the multivariate model b is described as a PCA model. The multivariate model b is generated using the process parameter data aₙ(tₘ) for a subset of times tₘ falling in a stable time period 52. The stable time period 52 is that where the process 16 is normal and stable and is generally described as a time period that does not include and is sufficiently spaced apart from abnormal events such as start-ups, plant trips, post ignition events, and the like. Referring to FIG. 3, process parameter data aₙ(tₘ) that represents one of the process parameters aₙ is illustrated. The process parameter data aₙ(tₘ) is substantially stable (within normal operating boundaries 53) up until a post ignition event 54 although the process 16 as a whole is unstable during an unstable time period 56 leading up to the post ignition event 54. Since univariate analysis of the process parameter aₙ of FIG. 3 does not permit the unstable time period 56 of the process 16 to be identified, the illustrated stable time period 52 is selected well before the post ignition event 54 to be sure that the stable time period 52 does not overlap the unstable time period 56.

The multivariate model b is generated according to an exemplary method. For each process parameter aₙ, the mean value a_{n,avg} of the process parameter data aₙ(tₘ) in the stable time period 52 is subtracted from the process parameter data aₙ(tₘ) to generate adjusted process parameter data a_{n,adj}(tₘ) according to an equation that can be given as a_{n,adj}(tₘ)=aₙ(tₘ)−a_{n,avg}. The covariance matrix is then generated for the entire set of adjusted process parameter data a_{n,adj}(tₘ) and the eigenvectors and the eigenvalues of the covariance matrix are found. The covariance matrix is an N×N matrix and there are N eigenvalues and N eigenvectors. Each eigenvector is a 1×N vector that is indexed by a subscript “p” where p ranges from 1 to N. Each eigenvector includes weights. The eigenvectors are ordered from lowest to highest according to the order of the values of the eigenvalues. The lower values of p represent the lower ordered eigenvectors and the higher values of p represent higher ordered eigenvalues. The eigenvectors can be represented in matrix form as

$${e}_{pn} = [ \overline{\begin{matrix}{e}_{11} & … & {e}_{1 N} \\ ⋮ & ⋱ & ⋮ \\ {e}_{N 1} & … & {e}_{NN}\end{matrix}} ] .$$

Each eigenvector includes the weights e_{p,n} of a principle component cₚ of the multivariate model b and principle component data cₚ(tₘ) can be given by the equation

$${c}_{p} ( {t}_{m} ) = {\sum }_{n}^{N} {e}_{p , n} ⋆ {a}_{n} ( {t}_{m} ) .$$

According to a second step 60, the unstable time period 56 is identified. The principle component data cₚ(tₘ) can be combined or processed to generate multivariate model data b(tₘ). For example, the multivariate model data b(tₘ) can be the sum of the principal component data cₚ(tₘ). Referring to FIG. 4, the multivariate model data b(tₘ) is plotted. Here, the unstable time period 56 leading up to the post ignition event 54 is reflected in the multivariate model data b(tₘ) and is identified. The unstable time period 56 can be identified as the time period where the multivariate model data b(tₘ) is operating outside normal operating boundaries 53 leading up to the post ignition event 54.

A fault, abonormality, or instability that resides somewhere in an industrial production process can be reflected in multivariate model data of the process. As used herein, a subspace where the fault, abnormality, or instability resides is termed an abnormal space. A fault, abnormality, or instability is not limited to a post ignition event or process conditions leading up to a post ignition event. Rather, a fault can include any cause of a deviation from normal process conditions. Normal process conditions can be identified, for example, with confidence intervals.

Multivariate models can identify general faults in the system but require application of engineering knowledge to identify specific events. To aid in the interpretation of fault signals in real-time it is helpful if a specific variable based on multivariate analysis can be linked with a specific type of event as described in further detail below.

### Identifying an Abnormal Space of the Process Space

According to a third step 62 of an exemplary method, an abnormal space where the instability of the process 16 resides during the unstable time period 56 is identified. For purposes of illustration, a process space includes all the process parameters aₙ and all the principle components cₚ of the multivariate model b. The abnormal space is a subspace of the process space. The third step 62 includes identifying principle components cₚ of the multivariate model b where instability is found and identifying process parameters aₙ of the multivariate model b that contribute to the instability of the process 16.

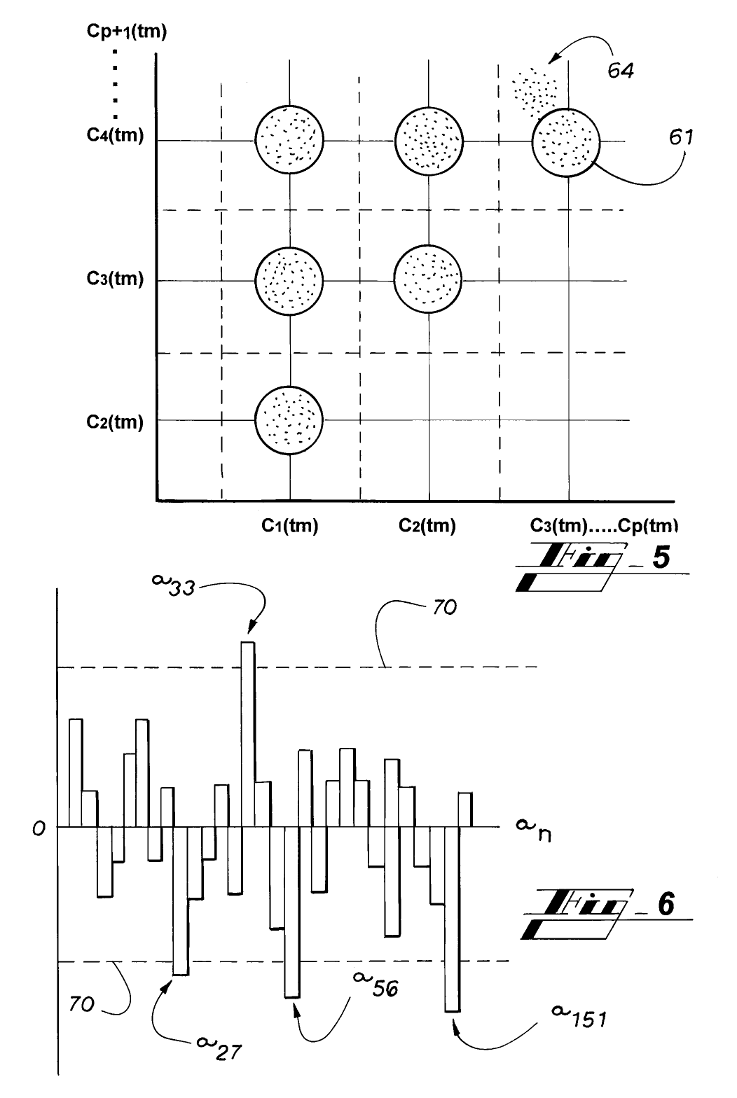

An exemplary method of identifying principle components c, of the abnormal space is now described. Referring to FIG. 5, each set of principle component data cₚ(tₘ) is plotted against the other sets of component data cₚ(tₘ) on a scatter plot. Each set of principle component data cₚ(tₘ) includes data in the unstable time period 56 leading up to the post ignition event 54. A monitoring region illustrated by a boundary line 61 represents normal behavior. For example, the boundary line 61 can represent a range of acceptable variation of the principle component data cₚ(tₘ) during the stable time period 52. To identify principle components cₚ where instability resides, the principle component data cₚ(tₘ) in the unstable time period 56 is analyzed to determine if the principle component data cₚ(tₘ) falls inside or outside the monitoring region defined by the boundary line 61. In general, principle component data cₚ(tₘ) that fall inside the boundary line 61 represent normal conditions and principle component data cₚ(tₘ) that fall outside the boundary line 61 represent abnormal conditions. If the number of principle component data cₚ(tₘ) outside the boundary line 61 is significant, the principle components are selected as components cₚ of the abnormal space. For purposes of illustration, the scatter plot of principle component data c₃(tₘ), c₄(tₘ) includes a significant amount of data outside the boundary line 61 (see data 64) and principle components c₃, c₄ are identified as components cₚ of the abnormal space. A p-subset that identifies the components cₚ of the abnormal space includes 3 and 4. In the illustrated embodiment, the instability of the process 16 is reflected in higher order principle component data cₚ(tₘ). Where the abnormal space includes higher order components, the instability of the process 16 may not be well-reflected in the multivariate model data b(tₘ) as the lower order components can dominate or dilute the instability reflected in the higher order components.

An exemplary method of identifying process parameters aₙ of the abnormal space is now described. Principal component data cₚ(tₘ) occurring outside the boundary line 61 may be influenced by any number of the process parameters aₙ. Referring to FIG. 6, the impact of each process parameter aₙ on movement of the multivariate model data b(tₘ) is assessed with a contribution plot. The contribution plot is a plot of contribution versus process parameter aₙ. The contribution of a process parameter aₙ can be calculated as a function of the change in the value of the process parameter aₙ over a period of time multiplied by a function of the weights e_{p,n} of the principle components cₚ corresponding to the process parameter aₙ. For example, the function of the weights e_{p,n} of the principle components cₚ can be the sum of the weights e_{p,n}. Process parameters aₙ that have a contribution that is greater than a contribution threshold 70 are selected as process parameters aₙ of the abnormal space. Here, an n-subset that identifies process parameters aₙ of the abnormal space includes process parameters a₂₇, a₃₃, a₅₆, and a₁₅₁.

Alternatively, other methods of calculating the contribution of a process parameter aₙ can be used. The impact of each process parameter aₙ on movement of principle component data cₚ(tₘ) can be assessed to determine contribution for each component cₚ. For example, the contribution of a process parameter aₙ to principle component data cₚ(tₘ) can be calculated as the change in the value of a process parameter aₙ over a period of time multiplied by the weight e_{p,n} of the principle component cₚ corresponding to the process parameter aₙ.

In the exemplary embodiment, the process parameters aₙ that are identified as process parameters aₙ of the abnormal space include inlet methane concentration, inlet and outlet ethylene concentration, inlet water concentration, and other parameters that are functions of the difference between inlet and outlet ethylene oxide concentration adjusted for the volume shrinkage of the gas, the difference between inlet and outlet ethylene concentration adjusted for the volume shrinkage of the gas, the difference between inlet and outlet oxygen concentration adjusted for the volume shrinkage of the gas, and the difference between inlet and outlet carbon dioxide concentration adjusted for the volume shrinkage of the gas, respectively.

### Monitoring Variable

Referring again to FIG. 2, according to a fourth step 72, the monitoring variable d is generated to monitor the abnormal space of the process 16. According to an exemplary embodiment, the monitoring variable d is a function of the n-subset of the process parameters aₙ and of the p-subset of principle components cₚ. The process parameters aₙ in the n-subset are weighted by a function of weights eₚ, of the principle components cₚ in the p-subset. For example, the monitoring variable d can be given as

$$d ( {t}_{m} ) = {\sum }_{n - subset} ( {\sum }_{p - subset} {e}_{n , p} ) ⋆ {a}_{n , adj} ( {t}_{m} ) .$$

The monitoring variable data d(tₘ) can reflect whether the process 16 is stable or unstable or otherwise whether a particular process fault is present.

An exemplary embodiment of the monitoring variable d can be a function of inlet methane concentration (CH₄)ᵢₙ, inlet ethylene concentration (C₂H₄)ᵢₙ, inlet water concentration (H₂O)ᵢₙ, outlet ethylene concentration (C₂H₄)ₒᵤₜ, and other parameters S₁, S₄, S₆ given as

$$d = 0.541 {a}_{1 , adj} - 0.321 {a}_{2 , adj} - {0.029}_{3 , adj} + 0.609 {a}_{4 , adj} - 0.552 {a}_{5 , adj} - 0.443 {a}_{6 , adj} + 0.207 {a}_{7 , adj}$$

$$where$$

$${a}_{1 , adj} = \frac{( {S}_{1} - {S}_{1 , avg} )}{{S}_{1 , Stdev}} , {a}_{2 , adj} = \frac{( {S}_{4} - {S}_{4 , avg} )}{{S}_{4 , Stdev}} , {a}_{3 , adj} = \frac{( {S}_{6} - {S}_{6 , avg} )}{{S}_{6 , Stdev}} , \\ {a}_{4 , adj} = \frac{( {( {CH}_{4} )}_{in} - {( {CH}_{4} )}_{in , avg} )}{{( {CH}_{4} )}_{in , Stdev}} , {a}_{5 , adj} = \frac{( {( {C}_{2} {H}_{4} )}_{out} - {( {C}_{2} {H}_{4} )}_{out , avg} )}{{( {C}_{2} {H}_{4} )}_{out , Stdev}} , \\ {a}_{6 , adj} = \frac{( {( {C}_{2} {H}_{4} )}_{in} - {( {C}_{2} {H}_{4} )}_{in , avg} )}{{( {C}_{2} {H}_{4} )}_{in , Stdev}} , {a}_{7 , adj} = \frac{( {( {H}_{2} O )}_{in} - {( {H}_{2} O )}_{in , avg} )}{{( {H}_{2} O )}_{in , Stdev}} , \\ {S}_{1} = \frac{Δ E O}{Δ {C}_{2} {H}_{4}} ⋆ 100 \% , {S}_{4} = \frac{\frac{6}{5} ⋆ Δ {C}_{2} {H}_{4} - \frac{2}{5} ⋆ Δ {O}_{2}}{Δ {C}_{2} {H}_{4}} ⋆ 100 \% , \\ and {S}_{6} = \frac{Δ {C}_{2} {H}_{4} - \frac{1}{2} ⋆ Δ {CO}_{2}}{Δ {C}_{2} {H}_{4}} ⋆ 100 \% .$$

The parameters S1, S4, S6 are functions of the difference between inlet and outlet ethylene oxide concentration adjusted for the volume shrinkage of the gas ΔEO, the difference between inlet and outlet ethylene concentration adjusted for the volume shrinkage of the gas ΔC₂H₄, the difference between inlet and outlet oxygen concentration adjusted for the volume shrinkage of the gas ΔO₂, and the difference between inlet and outlet carbon dioxide concentration adjusted for the volume shrinkage of the gas ΔCO₂, respectively.

The process parameters aₙ of the exemplary monitoring variable d are adjusted by subtracting a respective average, as discussed with respect to adjusted process parameters a_{n,adj}(tₘ), and dividing by a respective standard deviation. The process parameters aₙ are reduced by a respective average in order to scale the process parameters aₙ relative to one another and the process parameters aₙ are divided by a respective standard deviation in order to eliminate the normal measurement noise for each individual process parameter aₙ.

Referring to FIG. 7, the monitoring variable data d(tₘ) is stable during the stable time period 52 and unstable during the unstable time period 56. Referring to FIG. 2, according to a fifth step 74, the monitoring variable d is implemented into the processor 26.

The abnormal space is small with respect to the process space. Accordingly, the monitoring variable d is able to efficiently generate monitoring variable data d(tₘ) in near-real time that is focused on aspects of the process 16 that can cause instability.

### Method of Operation

Referring to FIG. 1, an exemplary method of operation of the monitoring system 10 is now described. The monitoring system 10 substantially continuously measures values of process parameters aₙ with sensors 20. The data management station 22 collects the process parameter data aₙ(tₘ) at times tₘ and pre-processes the process parameter data aₙ(tₘ) to get a complete set of process parameter data aₙ(tₘ). Selected process parameter data aₙ(tₘ) is processed by the processor 26 or is otherwise input into the monitoring variable d to generate a monitoring variable data d(tₘ). The monitoring variable data d(tₘ) is output to the display module 30 where operators can monitor the monitoring variable data d(tₘ) for signs of instability, which can be indicated by variation or operation outside normal boundaries. Additionally or alternatively, the monitoring variable data d(tₘ) can be monitored by a computer that alerts operators when the process 16 is unstable. The computer can also initiate a prescribed method of correcting an unstable process 16.

As the exemplary monitoring variable d is associated with instability that leads to post ignition events, a specific procedure for stabilizing the process can be used when the instability of the process 16 is reflected in the monitoring variable data d(tₘ). In contrast, instability that is reflected in the multivariate model data b(tₘ) is not associated with a particular event but is rather a reflection of any source of instability. Accordingly, without knowing the source of the instability, it can be difficult to select a procedure for stabilizing the process.

The above-described embodiments are merely exemplary illustrations of implementations set forth for a clear understanding of the principles of the disclosure. Variations, modifications, and combinations may be made to the above-described embodiments without departing from the scope of the claims. All such variations, modifications, and combinations are included herein by the scope of this disclosure and the following claims.

What is claimed is:

1. A method for monitoring an industrial production process, comprising:
generating process data; and
calculating a value of a monitoring variable based at least in part on the process data, the monitoring variable being optimized with respect to an abnormal space of a process space, the process space comprising process parameters and principle components of a multivariate model of the process, the abnormal space being a subspace of the process space.

2. The method of claim 1, the abnormal space comprising a subset of the principle components consisting essentially of the principle components with corresponding principle component data that falls outside of a normal operation region as the principle components are plotted against one another.

3. The method of claim 2, the abnormal space comprising a subset of the process parameters consisting essentially of the process parameters that have a contribution that is greater than a predefined contribution threshold.

4. The method of claim 1, the abnormal space comprising a subset of the process parameters consisting essentially of the process parameters that are identified by a contribution analysis.

5. The method of claim 1, wherein the industrial production process comprises an ethylene oxide reactor process and the process parameters in the abnormal space consisting essentially of inlet methane concentration, inlet and outlet ethylene concentrations, inlet water concentration, inlet and outlet ethylene oxide concentrations, inlet and outlet oxygen concentrations, and inlet and outlet carbon dioxide concentrations.

6. The method of claim 1, wherein the industrial production process comprises an ethylene oxide reactor process and the process parameters in the abnormal space consisting essentially of inlet methane concentration, inlet and outlet ethylene concentrations, inlet water concentration, parameter S1, parameter S4, and parameter S6.

7. The method of claim 1, the monitoring variable being a function of a subset of the process parameters of the multivariate model that correspond to the abnormal space.

8. The method of claim 7, the monitoring variable being a function of a subset of the principle components of the multivariate model that correspond to the abnormal space.

9. The method of claim 7, the monitoring variable being a function of weights of the principle components of the subset of the principle components that correspond to the process parameters of the subset of the process parameters.

10. The method of claim 9, the monitoring variable being a function of the sum of the weights of the principle components of the subset of the principle components that correspond to a process parameter of the subset of the process parameters.

11. The method of claim 1, the monitoring variable being a function of a subset of the principle components of the multivariate model that correspond to the abnormal space.

12. The method of claim 1, further comprising determining whether the process is normal based upon the value of the monitoring variable.

13. A system for monitoring an industrial production process, comprising:
at least one sensor configured to facilitate generating process data; and
a processor configured to calculate a value of a monitoring variable using the process data, the monitoring variable being optimized with respect to an abnormal space of a process space, the process space comprising process parameters and principle components of a multivariate model of the process, the abnormal space being a subspace of the process space.

14. The system of claim 13, the processor being configured to calculate the value of the monitoring variable substantially as the process data is generated.

15. A method for developing a monitoring variable, comprising:
generating a multivariate model of an industrial production process using process data that corresponds to normal process conditions, the multivariate model comprising process parameters and principle components that provide a process space;
identifying an abnormal space that is a subspace of the process space using process data that corresponds to abnormal process conditions, the abnormal space comprising a subset of the process parameters and a subset of the principle components; and
developing a monitoring variable as a function of process parameters consisting essentially of the subset of the process parameters and as a function of principle components consisting essentially of the subset of the principle components.

16. The method of claim 15, the step of identifying the subset of the process parameters comprising applying a contribution analysis.

17. The method of claim 15, the step of identifying the subset of the principle components comprising plotting principle component data of a first principle component against principle component data of a second component.

18. The method of claim 15, the developing step comprising developing the monitoring variable as a function of weights of the principle components of the subset of the principle components that correspond to the process parameters of the subset of the process parameters.

19. The method of claim 18, the developing step comprising developing the monitoring variable as a function of the sum of the weights of the principle components of the subset of the principle components that correspond to a process parameter of the subset of the process parameters.

20. The method of claim 15, the process data that corresponds to abnormal process conditions is process data leading up to a post ignition event.
